(19) United States
(12) Patent Application Publication
(10) Pub. No.: US 2008/0016160 A1
(43) Pub. Date: Jan. 17, 2008

(54) Network provided integrated messaging and file/directory sharing

(75) Inventors: Edward Walter, Boerne, TX (US); Larry Pearson, San Antonio, TX (US); Matthew Bruening, San Antonio, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/486,067

(22) Filed: Jul. 14, 2006

(51) Int. Cl. G06F 15/16

(52) U.S. Cl. 709/206

(57) ABSTRACT

A client enables filing sharing from within an email application. The client includes a receiver that receives an instruction to share at least one file via an email application. The client also includes a transmission system that transfers the at least one file to a web server. The client further includes an email application component that embeds a link to a handle into an email to be sent, the handle identifying the file(s) on the web server.

### BACKGROUND

1. Field of the Disclosure

The present disclosure relates to telecommunications. More particularly, the present disclosure relates to embedding file sharing capabilities within an email application.

2. Background Information

In the past, file and directory sharing has been very cumbersome. Users either mark a file or directory as a share or use file transfer protocol (FTP) to transfer files via an FTP server. Another traditional approach to sharing a file is to place the file(s) on a form of media (i.e., CD, floppy disk, etc.) or email the file.

Emailing files is not a satisfactory solution because email systems typically place limits on the size of files allowed to be emailed and/or the type of files (e.g., file extension) allowed to be emailed.

There is a need for addressing the issues identified above.

### BRIEF DESCRIPTION OF THE DRAWINGS

FIG. 1 shows an exemplary general computer system that can operate within the embedded file share system;

FIG. 2 shows an exemplary system architecture, according to an aspect of the present disclosure;

FIG. 3 shows an exemplary notification configuration screen, according to an aspect of the present disclosure;

FIG. 4 shows an exemplary sending file/directory share screen, according to an aspect of the present disclosure; and

FIG. 5 shows an exemplary file/directory status screen, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

The present disclosure permits users of an email application to transmit files from within the email application while bypassing the email system and all of its associated limitations. The sender is unaware of the email system bypass. In one embodiment, the bypass is also transparent to the recipient.

In one aspect of the present invention, a computer readable medium stores a program for enabling file sharing from within a sending email application. The medium has an instruction receiving code segment that receives an instruction to share at least one file via an email application; an uploading code segment that transfers the file(s) to a web server; a handle receiving code segment that receives a handle for the transferred file(s); and a handle insertion code segment that embeds a link to the handle into an email to be sent. In one embodiment, the file(s) is at least one file directory.

In one embodiment, the instruction receiving code segment receives a limit of a number of allowed downloads of the shared file(s).

A link displaying code segment can display a link to the shared file at a client that receives the email when the receiving client runs an email application that differs from the sending email application.

An attachment icon displaying code segment can display an attachment icon associated with the shared file at a client that receives the email when the receiving client runs an email application that is the same as the sending email application.

A status code segment can display a status of shared files. The status code segment displays a time to live for each shared file. The status code segment can display a number of remaining downloads for each shared file.

In one embodiment, the instruction receiving code segment receives an instruction to convert the shared file(s) into a different file type, and the uploading code segment transfers a version of the at least one shared file that has been converted into the different file type. The different file type can be a portable document format (PDF).

In another aspect, an apparatus enables filing sharing from within an email application. The apparatus includes a receiver that receives an instruction to share at least one file via an email application; a transmission system that transfers the file(s) to a web server; and an email application component that embeds a link to a handle into an email to be sent. The handle identifies the file(s) on the web server. The file(s) can be at least one file directory.

In one embodiment, the receiver receives a time to live parameter that specifies how long the at least one shared file will remain on the web server. The receiver can also receive a time to live reminder parameter that specifies how long prior to expiration of the time to live parameter that a reminder will be sent.

The email application component can display a link to the shared file at a client that receives the email when the receiving client runs an email application that differs from the sending email application. The email application component can display an attachment icon associated with the shared file at a client that receives the email when the receiving client runs an email application that is the same as the sending email application.

A status system can display a status of shared files. The status system can display at least one of a time to live for each shared file, a number of remaining downloads for each shared file, and a file type for each shared file.

In one embodiment, the receiver also receives an instruction to convert the at least one shared file into a different file type, and the transmission system transfers a version of the at least one shared file that has been converted into the different file type. The different file type can be a portable document format (PDF).

In still another aspect, a computer readable medium stores a program including an email application component that displays an attachment icon associated with a shared file at a client that receives an email when the receiving client runs an email application that is the same as a sending email application, the shared file having been uploaded to a web server. The program also has a downloading code segment that downloads the shared file from the web server when the attachment icon has been selected.

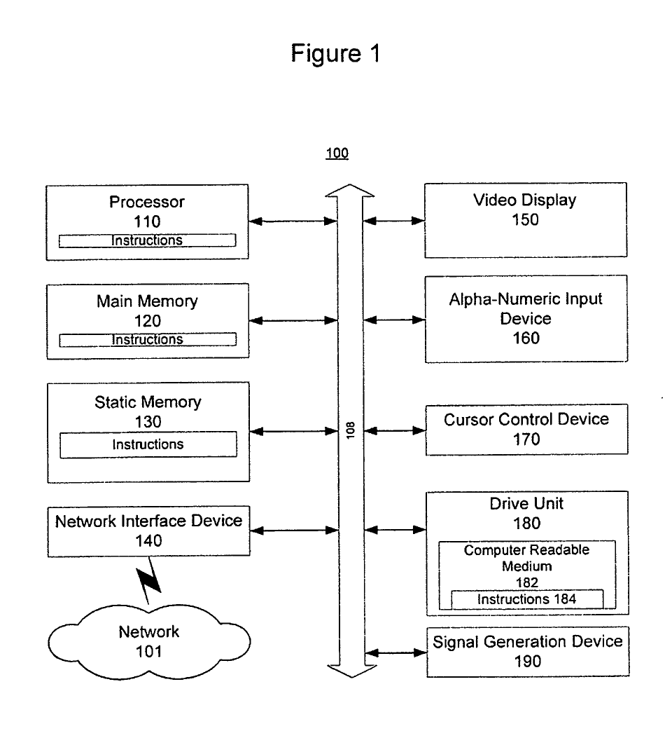

Referring to FIG. 1, a description is now provided of an illustrative embodiment of a general computer system 100, on which the embedded file sharing functionality can be implemented. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

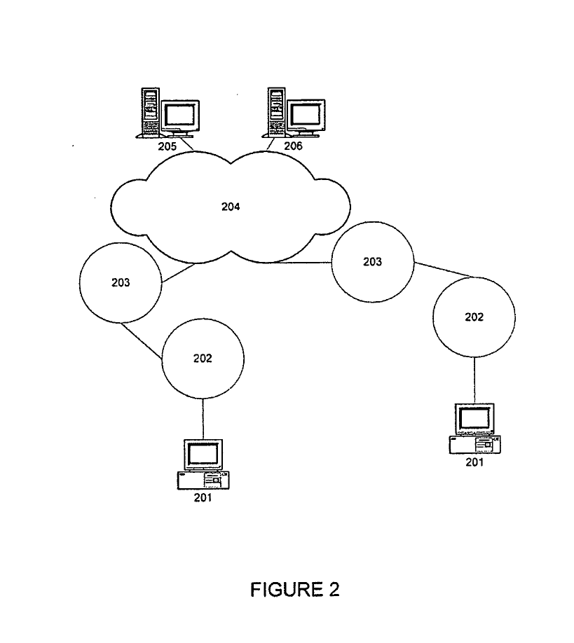

Referring to FIG. 2, an exemplary system architecture for embedded file sharing is described. Although file is frequently used throughout this description, it is understood that file also can encompass multiple files, as well as multiple files within a directory or directories.

A network attached computer 201 connects via switches 202 (e.g., Ethernet switches) and customer premises routers 203 to an Internet protocol (IP) network 204, such as the Internet. An existing email platform 205 also connects to the IP network 204, as does a file/directory share application server/database (for example a web server) 206. In one embodiment, the email platform 205 and file/directory share application server/database 206 are part of a service provider's messaging platform. In a unified messaging environment, the email platform 205 can also include a voice mail platform. As can be seen, the user of the network attached computer 201 can access the email/voicemail platform 205 and the file/directory share application server/database 206 via the IP network 204.

In one embodiment, the voicemail/email platform 205 and file/directory share application server/database 206 are separate hardware components and/or software modules. In one embodiment, the separate systems 205, 206 share common components or functions, such as authentication.

In one aspect, the present disclosure permits users of an email application (e.g., Microsoft Outlook, or Mozilla Firefox, etc.) to transmit files from an email application while bypassing the email platform 205. That is, the files can be sent via the IP network 204 to a web server 206. Even though the files are sent via the IP network 204 and web server 206, instead of the email platform 205, the transmitted file(s) appear to the sending users and receiving users as normally attached files sent via the email platform 205. Basically, the different form of transmission is hidden from the users.

In one embodiment, the receiving user has the same email application as the sending user, enabling hiding of the different type of file transmission from the receiving user. That is, the received email includes an icon that normally indicates an attached file. If the receiving user has a different email application, the receiving user sees a link to the file location, rather than the icon indicating a file has been attached.

In one embodiment, the disclosed programming can be provided as a plug-in to an email application. That is, the functionality could be a third party add-on running within the email execution environment. In another embodiment, the functionality is provided as part of the email application itself.

From the sending application's perspective, the file(s) to be sent are transferred to the file/directory share application server/database 206, in one embodiment via a standard HTTP post executed in the background. Subsequently, a handle to the file is retrieved and the handle is embedded within the email. When the user instructs the email to be sent, the email and the embedded link are sent to the recipient. In one embodiment, the embedded link is displayed as a standard email attachment icon.

Upon clicking on the link/icon, the receiving user's email application downloads the file from the file/directory share application server/database 206. In one embodiment, the receiving user is not notified by the email application of the downloading process, but rather the download occurs in the background. The file can be downloaded via a standard HTTP request.

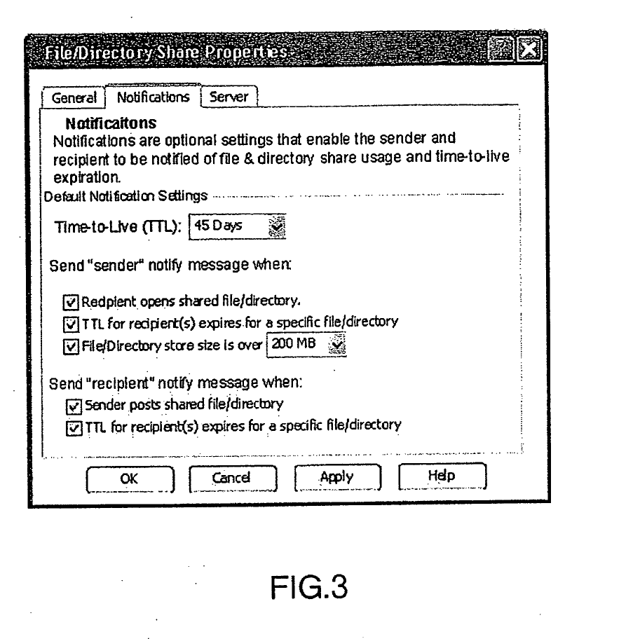

Configuration of the email file sharing system will now be discussed with respect to FIG. 3. A user can be provided with a variety of ways to access configuration properties. For example, a user can select a menu item on an email application tool bar and then select a “Settings” option. Alternatively, the user can select an icon in a short cut bar, for example by right clicking the icon and selecting “Properties.” Although not described, other manners of accessing the configuration settings are also envisioned. Once the configuration properties are accessed, a “File/Directory Share Properties” property box appears. In the embodiment shown in FIG. 3, the property box has three tabs. Although not shown in detail, a “General” tab allows the user to enter the email user's name (e.g., Edward Walter), email account (e.g., ed_walter@ATT.com), file/directory account username (e.g., ed_walter@ATT.com), and a password. In one embodiment, the username defaults to the email account, but it can be changed to anything else the customer wishes.

The user also has the option of converting all documents into a standard format, e.g., portable document format (PDF), by checking a “PDF Convert” check box, which may also be provided under the “General” tab. At the time of actually sending each email, the sender has the option to override the default value set in the configuration, as discussed later.

A “Notifications” tab offers several notification options to the user, examples of which are depicted in detail. For example, a time-to-live option can be set. This option indicates how many days the shared file(s) will be available before it is deleted from the file/directory share application server/database 206.

From the “Notifications” tab, notifications can be configured to be sent to the sender. For example, a notification can be sent to inform the sender when a recipient opens the shared file/directory. A notification can be sent to inform the sender when a time-to-live expires for a specific file/directory. Also, a notification can be sent when a file/directory is larger than a user specified size. The user selects the notifications by checking the corresponding boxes on the “Notifications” tab.

From the “Notifications” tab, notifications can also be configured to be sent to the recipient. For example, the recipient can be notified when a sender posts the shared file/directory. A notification can also be sent to inform the recipient when a time-to-live expires for a specific file/directory.

Although not shown in detail, a “Server” tab enables a user to configure server connectivity, e.g., port numbers, encryption options, digital Ids, etc.

In order to share a file/directory, the user can select a “File/Directory” option from the menu bar, or can alternatively select a “File/Directory Share” button on a toolbar. Of course, other ways to access the “File/Directory Share” screen are also envisioned and the described examples are intended to be non-limiting. In any event, once the user takes the appropriate action, a “File/Directory Share” screen appears.

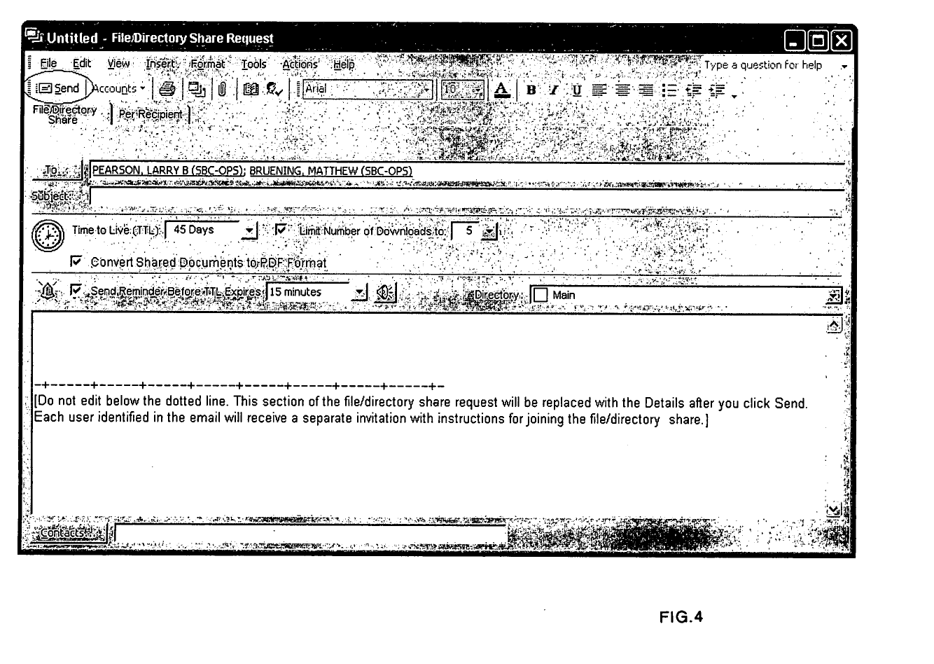

FIG. 4 shows an exemplary “File/Directory Share” screen. As with standard email messages, at least one recipient (or a distribution group) of the email is input in the “To” field. The sender can also designate the time-to-live (overriding the default value), as well as whether a reminder will be sent prior to expiration of the time-to-live. The number of times the recipients can download the shared file/directory can also be specified. A check box can be provided to indicate whether the file is to be converted, e.g., to PDF, possibly overriding the default setting.

The file/directory to be sent can be inserted in a standard manner, after the user selects a share icon (shown as overlaid papers) or selects insert from the menu, instead of the usual paper clip icon used for file attachments. A “Directory” drop down menu can be provided to allow the user to organize shared files in a hierarchy. From the “File/Directory Share” screen, a “Per Recipient” tab can be selected to enable the user to customize the default settings for each user. For example, the notifications can be configured from the “Per Recipient” tab (not shown in detail). By pressing the “Send” button, the email is sent with a link/icon and with the shared file/directory transmitted as discussed above.

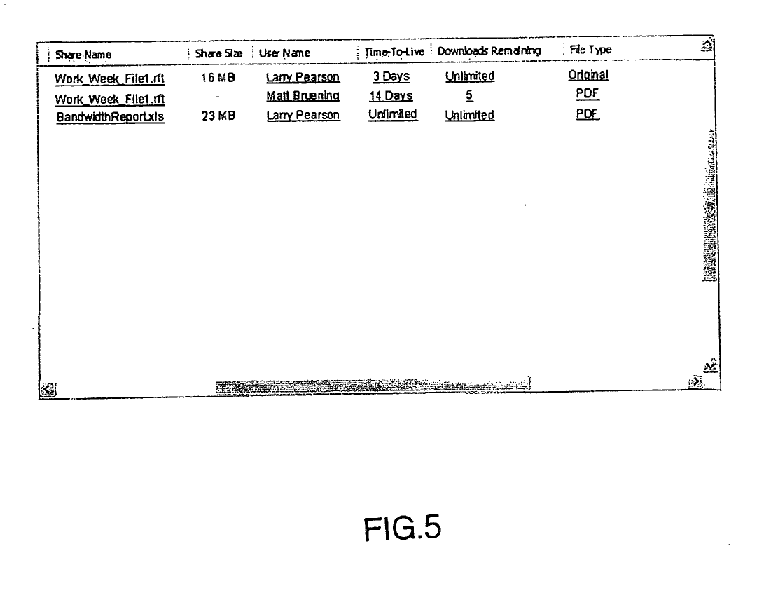

According to an aspect of the present disclosure, a user can monitor the status of shared files/directories. As with the other features, access to the status can be provided in multiple ways, for example via an icon on a shortcut bar. FIG. 5 shows an exemplary status screen. In one embodiment, the status includes the name of the shared file/directory (Share Name), the share size, the name of the recipient(s) with access to the shared file/directory (User Name), the remaining time available to access (Time-To-Live), the number of downloads remaining (Downloads Remaining), and the file type.

Each field can have a hyperlink capability that allows modification of the content and general trend information, such as how often it was accessed, who accessed it, how much data was transferred, etc. For example, clicking on the user would show all files to which this user has access. Deleting the user would remove access to the shares and would send an email notifying the deleted user of his loss of access.

By clicking on “Time-To-Live” and “Downloads Remaining,” the shown values could be adjusted. Clicking on the “File Type” hyperlink changes the file type. If a PDF version is posted, and the user would like to change the file type to the native format, the system prompts the user to re-download the file from the local source. All users with the PDF version will be notified of the new shared file. In one embodiment, the sort order can be based on shared files, enabling viewing of all email sent that shared a particular file.

In one embodiment, the system can alert a user when an email attachment exceeds a limitation of the email system, e.g., file size limitation. The embedded file sharing capability can then re-send the attached file as an embedded link. Either the client 201 or the server 206 could implement this functionality.

Thus, it can be seen that embedding file sharing capabilities into an email client simplifies a user's actions for sharing files and groups of files (in a directory) with other users. The share process becomes transparent to the sender and also possibly the recipient. Moreover, the embedded file sharing overcomes file size and/or file type limitations of an email system. Finally, the embedded file sharing eliminates the need for any special type of file shares, permitting the user to share files from within a familiar email environment when notifying the recipient of the access.

Although the present specification describes components and functions that may be implemented in particular embodiments with reference to particular standards and protocols, the invention is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A computer readable medium storing a program for enabling file sharing from within a sending email application, the medium comprising:
an instruction receiving code segment that receives an instruction to share at least one file via an email application;
an uploading code segment that transfers the at least one file to a web server;
a handle receiving code segment that receives a handle for the transferred file; and
a handle insertion code segment that embeds a link to the handle into an email to be sent.

2. The medium of claim 1, in which the at least one file comprises at least one file directory.

3. The medium of claim 1, in which the instruction receiving code segment receives a limit of a number of allowed downloads of the shared at least one file.

4. The medium of claim 1, further comprising a link displaying code segment that displays a link to the shared file at a client that receives the email when the receiving client runs an email application that differs from the sending email application.

5. The medium of claim 1, further comprising an attachment icon displaying code segment that displays an attachment icon associated with the shared file at a client that receives the email when the receiving client runs an email application that is the same as the sending email application.

6. The medium of claim 1, further comprising a status code segment that displays a status of shared files.

7. The medium of claim 6, in which the status code segment displays a time to live for each shared file.

8. The medium of claim 6, in which the status code segment displays a number of remaining downloads for each shared file.

9. The medium of claim 1, in which the instruction receiving code segment receives an instruction to convert the at least one shared file into a different file type, and the uploading code segment transfers a version of the at least one shared file that has been converted into the different file type.

10. The medium of claim 9, in which the different file type comprises portable document format (PDF).

11. An apparatus for enabling filing sharing from within an email application, the apparatus comprising:
a receiver that receives an instruction to share at least one file via an email application;
a transmission system that transfers the at least one file to a web server; and
an email application component that embeds a link to a handle into an email to be sent, the handle identifying the at least one file on the web server.

12. The apparatus of claim 11, in which the at least one file comprises at least one file directory.

13. The apparatus of claim 11, in which the receiver further a time to live parameter that specifies how long the at least one shared file will remain on the web server.

14. The apparatus of claim 13, in which the receiver further receives a time to live reminder parameter that specifies how long prior to expiration of the time to live parameter that a reminder will be sent.

15. The apparatus of claim 11, in which the email application component displays a link to the shared file at a client that receives the email when the receiving client runs an email application that differs from the sending email application.

16. The apparatus of claim 11, in which the email application component displays an attachment icon associated with the shared file at a client that receives the email when the receiving client runs an email application that is the same as the sending email application.

17. The apparatus of claim 11, further comprising a status system that displays a status of shared files.

18. The apparatus of claim 17, in which the status system displays at least one of a time to live for each shared file, a number of remaining downloads for each shared file, and a file type for each shared file.

19. The apparatus of claim 11, in which the receiver further receives an instruction to convert the at least one shared file into a different file type, and the transmission system transfers a version of the at least one shared file that has been converted into the different file type.

20. The apparatus of claim 19, in which the different file type comprises portable document format (PDF).

21. A computer readable medium storing a program, comprising:
an email application component that displays an attachment icon associated with a shared file at a client that receives an email when the receiving client runs an email application that is the same as a sending email application, the shared file having been uploaded to a web server; and
a downloading code segment that downloads the shared file from the web server when the attachment icon has been selected.
